(19) United States
(12) Patent Application Publication
(10) Pub. No.: US 2020/0220741 A1
(43) Pub. Date: Jul. 9, 2020

(54) System and Method for Modeling an Asynchronous Communication Channel

(71) Applicant: EtherLabs, Inc., Austin, TX (US)

(72) Inventors: Krishna Sai, Round Rock, TX (US); Cullen Childress, Austin, TX (US)

(21) Appl. No.: 16/277,327

(22) Filed: Feb. 15, 2019

(30) Foreign Application Priority Data
Jan. 3, 2019 (IN) 201911000371

(51) Int. Cl. H04L 12/18; H04L 29/08

(52) U.S. Cl. CPC H04L 12/1831; H04L 67/26; G06F 17/2705; H04L 12/1863; H04L 67/1095; H04L 12/1859

(57) ABSTRACT

A method includes providing an asynchronous communication channel. The method further includes generating a customized channel model of the asynchronous communication channel based on one or more machine learning techniques and messages received through the asynchronous communication channel. The method further includes outputting data to the asynchronous communication channel based on the customized channel model of the asynchronous communication channel.

### PRIORITY

This application claims priority to Indian Provisional Patent Application No. 201911000371, filed on Jan. 3, 2019, the content of which is hereby incorporated in its entirety.

### TECHNICAL FIELD

The present disclosure relates to communication systems.

### BACKGROUND

In the modern world, groups of people collaborate on various projects from distinct locations. For example, a business may include teams located in different cities or countries. Such teams may be tasked with collaborating to accomplish various goals of the business. Even members of a particular team may be distributed across multiple locations. For example, some members may work from home while others work from an office building. In order to facilitate collaboration between team members and/or teams in various locations, businesses use different communication technologies. Such communication technologies include chat applications. These chat applications support creation of groups (e.g., “channels”) that may be used by members of the channel to asynchronously exchange information. For example, users may post text, audio, video, etc. to the channel to be reviewed by other members another time. While information in the channel may be accessed asynchronously, in practice, a frequency of accesses to information in the channel may be a function of time. To illustrate, as newer information is posted to the channel, older information may be accessed by members less frequently or not at all.

### SUMMARY

Systems and methods of modeling channel conversations are disclosed. The disclosed systems and methods analyze content of an asynchronous communication channel (e.g., a chat channel)) to develop a customized model of the channel. This customized model provides a contextual representation of conversations within the channel and captures intent of the channel, attention of the channel, and behavioral transition of the channel. As used herein, intent refers to a theme of a channel, attention refers to what topics are discussed at a particular point in time or overall within the channel, and behavioral transition refers to how intent and attention change over time. According to the disclosed systems and methods, the customized model of the channel may be used to perform one or more of several functions.

One such function includes providing a summary of a synchronous communication session. For example, according to some examples of the disclosed systems and methods, a synchronous communication session (e.g., teleconference) may be launched from within an asynchronous communication channel (e.g., a chat channel). The disclosed systems and methods may apply a customized model of the asynchronous communication channel to a transcript of the synchronous communication session to identify significant moments in the synchronous communication session. The disclosed systems and methods may then publish transcripts and/or links to recordings of the identified significant moments.

Another function includes extracting key phrases from a synchronous communication session. For example, the disclosed systems and methods may identify key phrases used in the synchronous communication session by applying the customized model of the asynchronous communication channel to the transcript of the synchronous communication session. The disclosed systems and methods may then publish a list of the key phrases and/or links to recordings of segments that include the key phrases to the asynchronous communication channel.

Another function includes identifying related asynchronous communication channels. For example, the disclosed systems and methods may support multiple asynchronous communication channels (e.g., chat channels). The disclosed systems and methods may identify a channel related to a first channel by comparing customized channel models of the two channels. The disclosed systems and methods may then publish an identifier and/or link to the related channel in the first channel.

Another function includes identifying products related to an asynchronous channel. For example, the disclosed systems and methods may maintain or otherwise have access to a database of products that associates various descriptors to the products. Based on a comparison of the descriptors to a customized channel model of an asynchronous channel, the disclosed systems and methods may identify a product relevant to the asynchronous channel. The disclosed systems and methods may then publish a description and/or a link to more information regarding the product to the asynchronous channel.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a block diagram illustrating a system for generating a model of an asynchronous communication channel;

FIG. 2 is a block diagram of the system for generating a model of the asynchronous communication channel illustrating the system providing a summary of a synchronous communication session based on the model;

FIG. 3 is a block diagram of the system for generating a model of the asynchronous communication channel illustrating the system providing a recommendation based on the model;

FIG. 4 is a diagram illustrating generation of models of asynchronous communication channels;

FIG. 5 is a flowchart illustrating a method for associating a template channel model with a channel;

FIG. 6 is a flowchart illustrating a method of replacing a template channel model with a customized channel model;

FIG. 7 is a flowchart illustrating a method of identifying synchronous communication session segments based on a channel model;

FIG. 8 is a flowchart illustrating a method of identifying keywords of a synchronous communication session based on a channel model.

### DETAILED DESCRIPTION

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the term “computing device” may refer to a device that includes, but is not limited to a single computer, host, server, laptop, and/or mobile device.

As used herein, the term “network device” may refer to any device that is capable of communicating and transmitting data to another device across any type of network.

As used herein, the term “computing system” may refer to a single electronic computing device or network device that includes, but is not limited to a single computer, virtual machine, virtual container, host, server, laptop, and/or mobile device. The term “computing system may also refer to a plurality of electronic computing devices and/or network devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example embodiments of an application include software modules, software objects, software instances and/or other types of executable code.

Sequences of method steps presented herein are provided as examples and are not meant to be limiting. Thus, methods may be performed in an order alternative to that illustrated in the figures and described herein. To illustrate, a method described as including steps “A” and “B” may be performed with “A” either preceding or following “B,” unless a specific order is indicated.

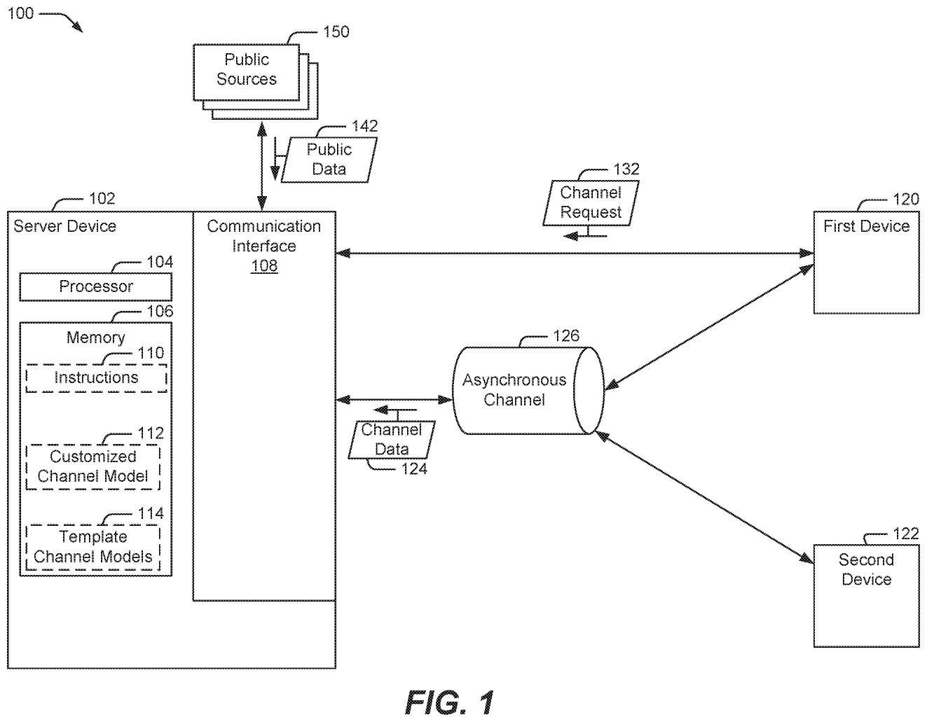

Referring to FIG. 1, a block diagram illustrating a system 100 for modeling an asynchronous communication channel is shown. The system 100 includes a server device 102. The server device 102 includes a processor 104, a memory 106, and a communication interface 108, each of which is described further below. In some implementations, the server device 102 includes further components in addition to those illustrated. It should be noted that while illustrated as a single device, the server device 102 may correspond to a plurality of devices, such as cloud computing service.

The processor 104 corresponds to one or more processing devices, such as one or more central processing units (CPUs), one or more other types of processing devices, or a combination thereof. The memory 106 corresponds to one or more computer-readable storage devices, such as one or more random-access memory devices, one or more optical devices (e.g., a compact disc, etc.), one or more hard disk drives, one or more flash memory devices, one or more other types of computer-readable storage devices, or a combination thereof. As used herein, a computer-readable storage device refers to a physical device. The memory 106 stores instructions 110 that are executable by the processor 104 to perform one or more of operations as described herein.

The communication interface 108 corresponds to one or more communication devices, such as one or more wireless interfaces (e.g., an 802.11 interface), one or more wired interfaces (e.g., an Ethernet interface), or a combination thereof. The server device 102 is configured to communicate with one or more devices via the communication interface 108. In the illustrated example, the server device 102 is configured to communicate with a first device 120, a second device 122 via the communication interface 108, and one or more public sources 150. Each of the devices 120, 122 corresponds to a different computing device, such as a mobile phone, a desktop computing, tablet computer, any other type of computing device, or a combination thereof. The one or more public sources 150 may correspond to computing devices coupled to a public network (e.g., the Internet) that host and distribute information (e.g., blogs, news posts, forums, web pages, etc.). It should be noted that, in some implementations, the server device 102 communicates with more or fewer devices than shown in FIG. 1. While not illustrated, some communications may be transmitted through one or more networks (e.g., the Internet).

In operation the server device 102 generates template channel models 114 based on public data 142 retrieved from the public sources 150. The server device 102 may generate a template channel mode for each of several topics by retrieving data from sources of the public sources 150 associated with those topics. For example, the server device 102 may generate an engineering template channel model based on data from sources associated with engineering (e.g., engineering blogs, forums, publications, etc.) and may generate a marketing template channel model based on data from sources associated with marketing. Further, the server device 102 may generate a general template channel model based on all the public data 142 retrieved from the public sources 150 or based on data retrieved from public sources associated with general topics.

Each of the template channel models 114 may correspond to a fixed sized representation of public data used to generate the template channel model 114. In some implementations the template channel models 114 correspond to N-dimensional hyper vector space models. The server device 102 may generate the template channel models 114. Generation of models is described further below. The server device 102 stores the template channel models 114 in the memory 106.

The server device 102 is configured to provide asynchronous communication channels. An asynchronous communication channel is a communication channel in which participants need not be present simultaneously to participate. An example of an asynchronous communication channel is a chatroom. A first device associated with a first user may access the chatroom and transmit a message to the chatroom while a second device associated with a second user is not connected to the chatroom. The second device may access the chatroom at a later time and then receive and respond to the message. In contrast, a synchronous communication session (e.g., an audio and/or voice call) occurs in real time. Accordingly, a device not connected to a synchronous communication session may be unable to participate in the synchronous communication session. Establishing an asynchronous communication channel may include saving message data received from devices participating in the channel (e.g., in the memory 106), forwarding the message data to the devices participating in the channel, transmitting a graphical user interface based on the message data to the devices participating in the channel, or a combination thereof.

In the illustrated example of FIG. 1, the server device 102 establishes an asynchronous communication channel 126 responsive to a channel request 132 from the first device 120. The asynchronous communication channel 126 is accessible to the first device 120 and the second device 122. The channel request 132 includes a title or label to associate with the asynchronous communication channel 126. The title or label may be descriptive of an intended function of the asynchronous communication channel 126. The server device 102 assigns one of the template channel models 114 to the asynchronous communication channel 126 based on the title or label. For example, the server device 102 may determine whether any of the template channel models 114 matches the title or label and assign a matching template channel model to the asynchronous communication channel 126 if one is identified. If no matching template channel model is identified, the server device 102 may assign a generic (e.g., general) template channel model to the asynchronous communication channel 126. For example, each of the template channel models 114 may be associated with a collection of words (e.g., labels) and if the title or label of the asynchronous channel 126 is included in a collection of words of one of the template channel models 114, the server device 102 may assign that template channel model to the asynchronous channel 126. If the title or label is not included in any of the collections of words, the server device 102 may assign a generic template channel model to the asynchronous communication channel 126.

After a template channel model is assigned to the asynchronous communication channel 126, the server device 102 uses the template channel model to perform one or more functions described herein to provide data to the asynchronous communication channel 126. Further, the server device 102 analyzes channel data 124 received from the asynchronous communication channel 126 to generate a customized channel model 112. The channel data 124 may correspond to messages posted to the asynchronous communication channel 126.

Generation of the customized channel model 112 (and the template channel models 114) may include one or more machine learning techniques. These machine learning techniques may include a data enrichment process, a training process, and a generation process. The data enrichment process expands input seed data (e.g., the channel data 124 or the public data 142). The data enrichment process may include identifying key-phrases in the seed data using one or more key-phrase extraction algorithms (e.g., Stanford NLP, Spacy, etc.). The data enrichment process may further include using an n-gram extraction technique (e.g., NLTK n-gram extraction) to extract additional key-phrases from the seed data. The data enrichment process includes using key-phrases as search terms in a web-scraping and filtering operation on open data sources (e.g., the public sources 150). Results of the web-scraping operation are combined with the seed data to generate enriched seed data.

The server device 102 applies the training process to the enriched seed data. The training process includes word embeddings training or language model training.

Word embeddings training includes constructing fixed vector representations of words learned through neural networks that are trained using one or more of the following prediction tasks: predict the word given the surrounding words, predict surrounding words given a word, next character prediction, etc. Examples of embeddings training techniques are Word2Vec and FastText. The server device 102 learns word embeddings through transfer learning by using existing representations of a word and fine-tuning the representations to a current training data distribution. Word embedding training further includes analyzing quality of learned word embeddings by performing various tasks, such as similar word extraction and sentence completion.

Language model training includes determining probabilities of word sequences occurring together in training data using deep neural architectures. Example deep neural architectures include recurrent neural network (RNN) and long short-term memory (LSTM) based architectures. Examples of language model training techniques include universal language model fine-tuning for text (ULMFiT) and BERT.

The server device 102 performs a generation process based on the word embeddings model or the language model to generate a channel model (e.g., the customized channel model 112 or the template channel models 114).

If the training process resulted in a word embeddings model, the server device 102 performs an aggregation on the word embeddings model. The aggregation may include an averaging of word representations in the seed data. Alternatively, the aggregation may include determining a stacked power-means representation of the word embeddings. The aggregation of the word embeddings model is output as a channel model (e.g., the customized channel model 112 or the template channel models 114).

If the training process resulted in a language model, the server device 102 performs a language model feature ensembler process. The language model feature ensembler process includes passing text snippets (e.g., 8-20 words) through a trained language model to obtain feature representations of the snippets. The feature representations of the snippets are then aggregated into the channel model. In some examples, the channel model is further enhanced by fine-tuning of the trained language model for supervised tasks, such as next sentence prediction, sentence completion, etc.

The customized channel model 112 indicates intent, attention, and behavioral transition of the asynchronous communication channel 126. The intent is a theme of the asynchronous communication channel 126 and may be captured by determining an n-dimensional real valued feature representation of the channel data 124. The attention indicates topics that are currently focuses of the asynchronous communication channel 126 and is determined similarly to intent but more recent messages in the channel data 124 are assigned a higher weight that less recent messages. The behavioral transition indicates how intent and attention change over time.

Once a size of the channel data 124 received by the server device 102 satisfies a threshold, the server device 102 may replace the template channel model assigned to the asynchronous communication channel 126 with the customized channel model 112 to perform the functions described herein to provide data to the asynchronous communication channel 126. The channel model used to provide data to the asynchronous communication channel 126 may be referred to as the active channel model for the asynchronous communication channel 126. Because the customized channel model 112 represents intent, attention, and behavioral transition of the asynchronous communication channel 126, the server device 102 may use the customized channel model 112 to more accurately provide data that is relevant to the asynchronous communication channel 126. Further, by using one of the template channel models 114 to provide data that is relevant to the asynchronous communication channel 126, the system 100 may reduce cold start problems associated with machine learning techniques. Accordingly, the system 100 generates and uses new types of data (e.g., template channel models and customized channel models) to identify data that may be relevant to an asynchronous communication channel.

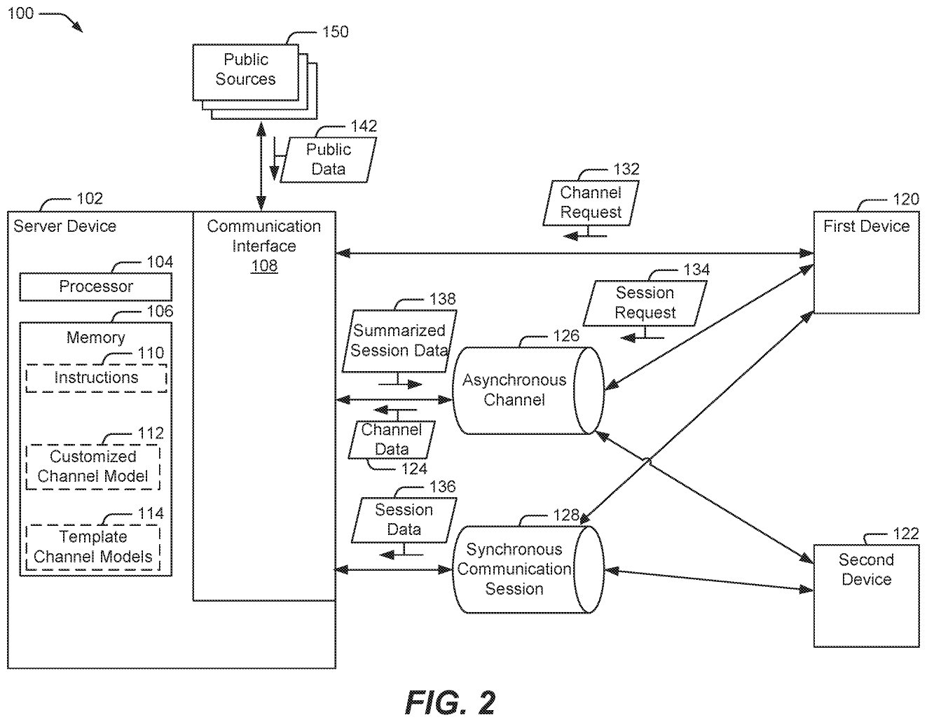

Referring to FIG. 2, an example of the system 100 in which a template channel model or a customized channel model is used to summarize a synchronous communication session are shown. As shown in FIG. 2, the first device 120 sends a synchronous communication session request 134 to the server device 102 via the asynchronous communication channel 126. For example, a user of the first device 120 may input “Launch synchronous app” into a chatroom that corresponds to the asynchronous communication channel 126. In response to the request 134, the server device 102 establishes a synchronous communication session 128 accessible to the devices 120, 122. For example, the server device 102 may create an audio and/or voice call and post an associated access link in the asynchronous communication channel 126. In the illustrated example, the first device 120 and the second device 122 join the synchronous communication session 128. Accordingly, users of the first device 120 and the third device 124 may communicate using the synchronous communication session 128.

During the synchronous communication session 128, the server device 102 receives session data 136 from the synchronous communication session 128. The session data 136 includes audio data from the synchronous communication session 128. Based on the session data 136, the server device 102 generates a text transcript of the synchronous communication session 128. Using whichever of the customized channel model 112 or one of the template channel models 114 is currently active for the asynchronous communication channel 126, the server device 102 generates summarized session data 138 based on the transcript. The summarized session data may include transcripts of segments of the synchronous communication session 128 identified as relevant to the asynchronous communication channel 126 based on the customized channel model 112 (or one of the template channel models 114), links to recordings of the relevant segments, relevant keywords spoken during the synchronous communication session 128, links to recordings to segments of the synchronous communication session 128 that include the keywords, or a combination thereof.

To illustrate, the server device 102 may generate a vector of features for each segment of the transcript of the asynchronous communication channel 126. The vector of features may be generated using one or more embedding aggregation techniques (e.g., stacked p-means), language model ensemble techniques, or a combination thereof, as described above with respect to channel model generation. Once the vectors are determined for the segments of the transcript, the server device 102 may determine distances between the vectors and the customized channel model 112 or the template channel model that is active for the asynchronous communication channel 126. The server device 102 may then determine which of the segments are relevant based on the distances. For example, the server device 102 may identify the x segments closest to the active channel model (e.g., the customized channel model 112 or one of the template channel models 114). As another example, the server device 102 may identify each segment that is within a threshold distance of the active channel model or a top x segments thereof. The server device 102 may output links to recordings of the identified segments, transcripts of the identified segments, or a combination thereof to the asynchronous communication channel 126 as part of the summarized session data 138.

As another example, the server device 102 may identify one or more initial keywords in the transcript of the synchronous communication session 128 using one or more context free keyword extraction algorithms (e.g., Spacy key-phrase extraction, NLTK n-gram extraction, etc.). The server device 102 may then generate feature vectors for each of the initial keywords and identify which of the initial keywords have feature vectors within a threshold distance of the active channel model. The server device 102 may further sort the identified keywords by distance from the active model. The server device 102 may then output the identified keywords, links to recorded segments of the synchronous communication session 128 that include the identified keywords, or a combination thereof to the asynchronous communication channel 126 as the summarized session data 138.

It should be noted that in some examples, the server device 102 is configured to maintain an index of summaries generated for the asynchronous communication channel 126. This index may include a list of summarized session data, such as the summarized session data 138, generated for the asynchronous communication channel 126. The server device 102 may be configured to return the index to the asynchronous communication channel 126 (or to a particular device, such as the first device 120) in response to a command received in the asynchronous communication channel 126 (e.g., “Show highlights of teleconferences”). In some implementations, the index may be searchable.

Thus, FIG. 2 illustrates that channel models (both customized channel models and template channel models) may be used to provide a summary of a synchronous communication session that may be more relevant to users of an asynchronous communication channel. Accordingly, information transmitted as part of the synchronous communication session may not be lost.

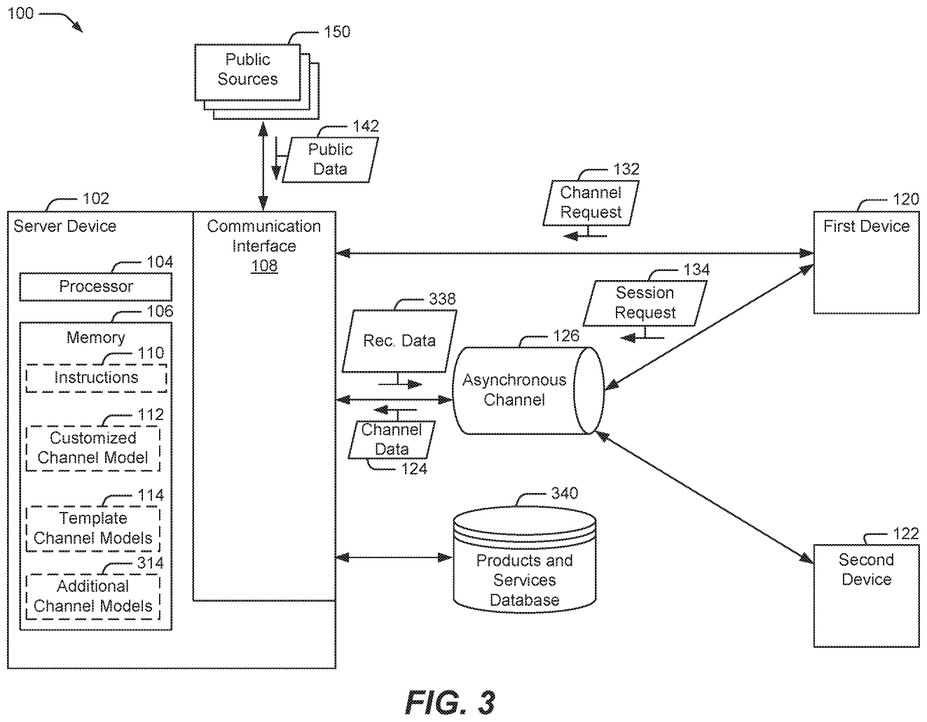

Referring to FIG. 3, an example of the system 100 in which the system 100 sends a recommendation to an asynchronous communication channel based on a template channel model or a customized channel model is shown. The server device 102 may send a recommendation to the asynchronous communication channel 126 based on the channel model active for the asynchronous communication channel 126 (e.g., the customized channel model 112 or one of the template channel models 114). In the illustrated example, the server device 102 sends recommendation data 338 to the asynchronous communication channel 126 based on the active channel model. The recommendation data 338 may include a link to another asynchronous communication channel, a link to a product or service, a description of product or service, or another type of recommendation. In some examples, the server device 102 is configured to make recommendations when a customized channel model (e.g., the customized channel model 112) is the active channel model but not when a template channel model is the active channel model.

In an illustrative example, the server device 102 identifies distances between the customized channel model 112 and additional channel models 314 associated with other asynchronous communication channels. The server device 102 includes in the recommendation data 338 links to asynchronous communication channels associated with channel models within a threshold distance of the customized channel model 112. Accordingly, the server device 102 may provide links to other channels that may be relevant to users of the asynchronous communication channel 126.

In another illustrative example, the server device 102 accesses a products and services database 340. FIG. 3 depicts the products and services database 340 as a computing device external to the server device 102 but the products and services database 340 may be a component of the server device 102 (e.g., stored in the memory 106). The products and services database 340 includes descriptions of various products and services and/or links to descriptions of products and services. In addition, for each product or service the object database 340 includes a feature vector. The server device 102 determines distances between the feature vectors of the products or services and the customized channel model 112 to identify any products or services within a threshold distance of the customized channel model 112. The server device 102 includes descriptions or links to descriptions of any identified products or services in the recommendation data 338. Accordingly, the server device 102 may provide descriptions or links to descriptions of products or services that may be relevant to users of the asynchronous communication channel 126. For example, the server device 102 may recommend particular software that may be used to address an engineering issue that is the attention of the asynchronous communication channel 126.

Thus, FIG. 3 illustrates that channel models (both customized channel models and template channel models) may be used to provide recommendations for additional information that may be relevant to users of an asynchronous communication channel.

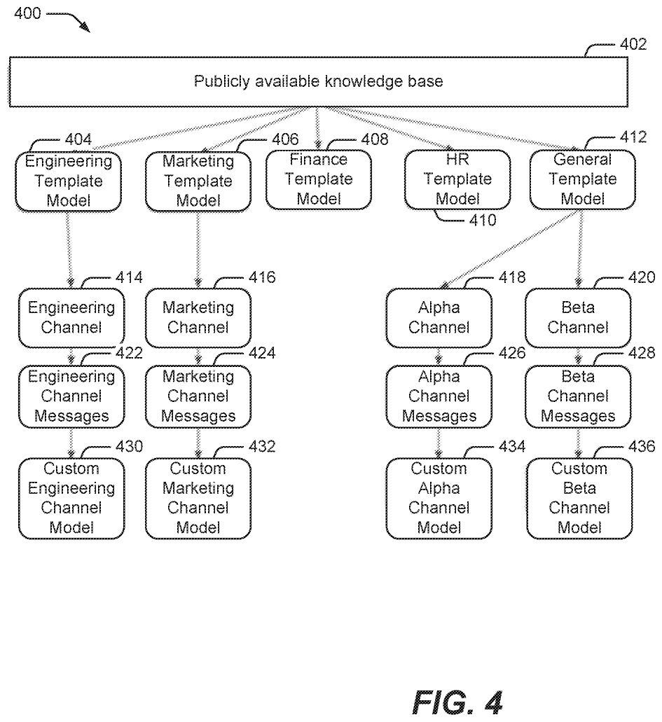

Referring to FIG. 4, a diagram 400 illustrating use of template channel models and customized channel models is shown. The diagram 400 shows that data from a publicly available knowledge base 402 is used to create template channel models. In particular, an engineering template model 404, a marketing template model 406, a finance template model 408, a human resources (HR) template model 410, and a general template model 412 are created based on the publicly available knowledge base 402. For example, the server device 102 may create the template channel models 402-412 based on the public data 142 from the public sources 150 as described herein. The engineering template model 404 may be created based on sources associated with engineering, the marketing template model 406 may be created based on sources associated with marketing, the finance template model 408 may be created based on sources associated with finance, and the HR template model 410 may be created based on sources associated with HR. The general template model 412 may be created based on a broad cross section of sources or based on sources associated with general information.

The diagram 400 illustrates the engineering template model 404 associated with an engineering channel 414, the marketing template model 406 associated with a marketing channel 416, and the general template model 412 associated with an alpha channel 418 and a beta channel 420. Each of the channels may correspond to a different asynchronous communication channel, such as the asynchronous communication channel 126. In an illustrative example, the server device 102 establishes each of the channels 414-420 based on requests (e.g., the channel request 132) received from one or more devices (e.g., the first device 120, the second device 122, etc.). The requests include the names of the channels. The name of the engineering channel 414 is “Engineering”, the name of the marketing channel 416 is “Marketing”, the name of the alpha channel 418 is “Alpha”, and the name of the beta channel 420 is “Beta”. The server device 102 then assigns a template channel model of the template channel models 114 to each of the channels based on the names. For example, the server device 102 may calculate a feature vector of the term “Engineering” and compare the feature vector to each of the models 404-410. In response to determining that a distance between the feature vector for “Engineering” is within a threshold distance of the engineering template model 404, the server device 102 may assign the engineering template model 404 to the engineering channel 414. The server device 102 may perform a similar process to assign the marketing template model 406 to the marketing channel 416. In contrast, the server device 102 may assign the general template model 412 to each of the alpha channel 418 and the beta channel 420 in response to determining that feature vectors of the terms Alpha and Beta are not within a threshold distance of any of the template models 404-410.

Each of the channels 414-420 receives messages. For example, users may post engineering channel messages 422 to the engineering channel 414, marketing channel messages 424 to the marketing channel 416, alpha channel messages 426 to the alpha channel 418, and beta channel messages 428 to the beta channel 420. The channel messages 422-424 may correspond to the channel data 124. As shown in the diagram 400, custom channel models are developed based on the channel messages 422-428. In particular, a custom engineering channel model 430 is generated based on the engineering channel messages 422, a custom marketing channel model 432 is generated based on the marketing channel messages 424, a custom alpha channel model 434 is generated based on the alpha channel messages 426, and a custom beta channel model 436 is generated based on the beta channel messages 428. For example, the server device 102 may generate the custom engineering channel model 430 based on the engineering channel messages 422 as described above. Once a volume of the engineering channel messages 422 reaches a threshold, the server device 102 may replace the engineering template model 404 with the custom engineering channel model 430 as the active channel model for the engineering channel 414. Similarly, the server device 102 may replace the template models 406, 412 with the custom channel models 432-436 as the active models for the channels 424-428 based on the respective volumes of the channel messages 424-428.

Thus, FIG. 4 illustrates how template channel models may be generated and assigned to asynchronous communication channels. FIG. 4 further illustrates how custom channel models may be generated based on communications received in asynchronous communication channel models. The custom channel models may replace the template channel models. Accordingly, data relevant to an asynchronous channel may be generated based on the template models until a custom channel model is completed and subsequently used to generate relevant data.

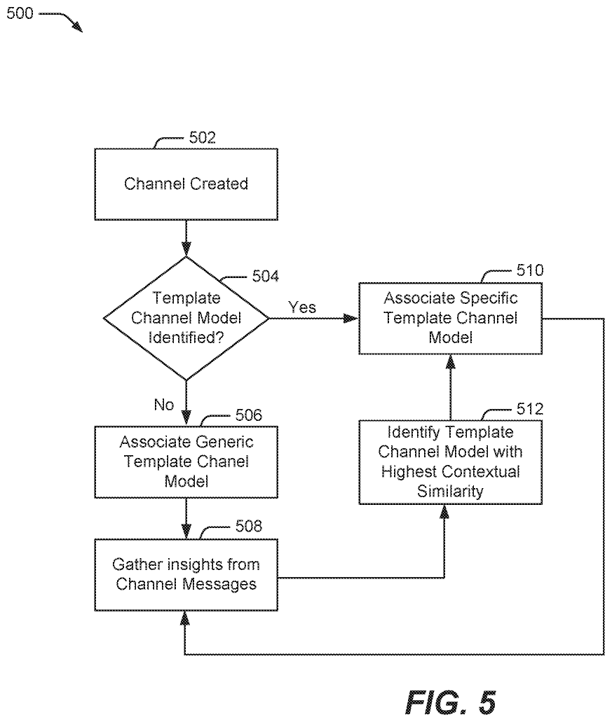

Referring to FIG. 5, a flowchart 500 illustrating a method for assigning a template channel model to an asynchronous communication channel is shown. The method 500 includes creating a channel, at 502. The method 500 further includes attempting to identify a template channel model, at 504. In response to determining that no template channel model is identified, the method 500 includes associating a generic template channel model, at 506. The method 500 further includes gathering insights from channel messages, at 508. The method further includes identifying a template channel model with highest contextual similarity, at 512. The method 500 further includes associating the specific template channel model with the channel, at 510. The method 500 further includes continuing to gather insights from the channel messages, at 508. In response to determining that a template channel model is identified, the method 500 includes associating the specific template channel model with the channel, at 510. The method 500 may continue until a threshold volume of messages have been received in the channel, at which point the active template channel model may be replaced by a customized channel model.

In a first illustrative example of the method 500, the server device 102 creates the asynchronous communication channel 126, as described with respect to 502. The server device 102 further determines whether a title, “Group 1” of the asynchronous communication channel 126 has a feature vector within a threshold distance of any of the template channel models 114, as described with respect to 504. In response to determining that none of the template channel models 114 is within a threshold distance of the feature vector, the server device 102 assigns a general template channel model to the asynchronous communication channel 126, as described with respect to 506. As the asynchronous communication channel 126 receives the channel data 124, the server device 102 constructs the customized channel model 112, as described with respect to 508. The messages are related to engineering. The server device 102 identifies that an engineering template channel model is a shortest distance from the customized channel model 112 under construction, as described with respect to 512. Accordingly, the server device 102 associates the engineering template channel model with the asynchronous communication channel 126, as described with respect to 510. Further, as the server device 102 receives more of the channel data 124, the server device 102 continues constructing the customized channel model 112, as described with respect to 508, and identifies a closest template channel model to the customized channel model 112, as described with respect to 512. For example, the server device 102 may replace the engineering template channel model with a mechanical engineering template channel model, as described with respect to 510.

In a second illustrative example of the method 500, the server device 102 creates the asynchronous communication channel 126, as described with respect to 502. The server device 102 further determines whether a title, “engineering” of the asynchronous communication channel 126 has a feature vector within a threshold distance of any of the template channel models 114, as described with respect to 504. In response to determining that an engineering template channel model is within the threshold distance, the server device 102 assigns the engineering template channel model to the asynchronous communication channel 126, as described with respect to 510. As the asynchronous communication channel 126 receives the channel data 124, the server device 102 constructs the customized channel model 112, as described with respect to 508. The messages are related to mechanical engineering. The server device 102 identifies that a mechanical engineering template channel model is now a shortest distance from the customized channel model 112 under construction, as described with respect to 512. Accordingly, the server device 102 associates the mechanical engineering template channel model with the asynchronous communication channel 126, as described with respect to 510.

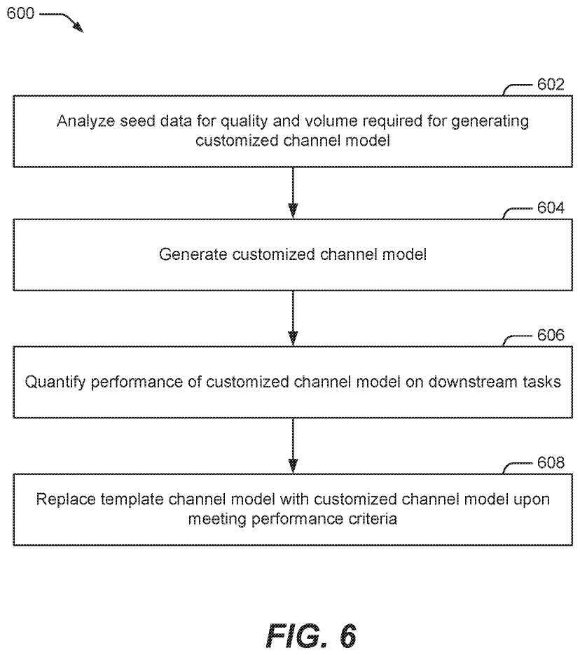

Referring to FIG. 6, a flowchart illustrating a method 600 of replacing a template channel model with a customized channel model is shown. The method 600 includes analyzing seed data for quality and volume required for generating a customized channel model, at 602. For example, the server device 102 may analyze the channel data 124 to determine whether the channel data 124 includes more than a threshold number of messages.

The method 600 further includes generating a customized channel model, at 604. For example, the server device 102 may generate the customized channel model 112 based on the channel data 124. The method 600 further includes quantifying performance of the customized channel model on downstream tasks, at 606. For example, the server device may generate a test version the summarized session data 138 and/or the recommendation data 338 based on the customized channel model 112 and solicit user feedback.

The method 600 further includes replacing the template channel model with the customized channel model upon meeting performance criteria, at 608. For example, the server device 102 may set the customized channel model 112 as the active channel model for the asynchronous communication channel 126 in response to determining that the user feedback indicates a score that satisfies a threshold.

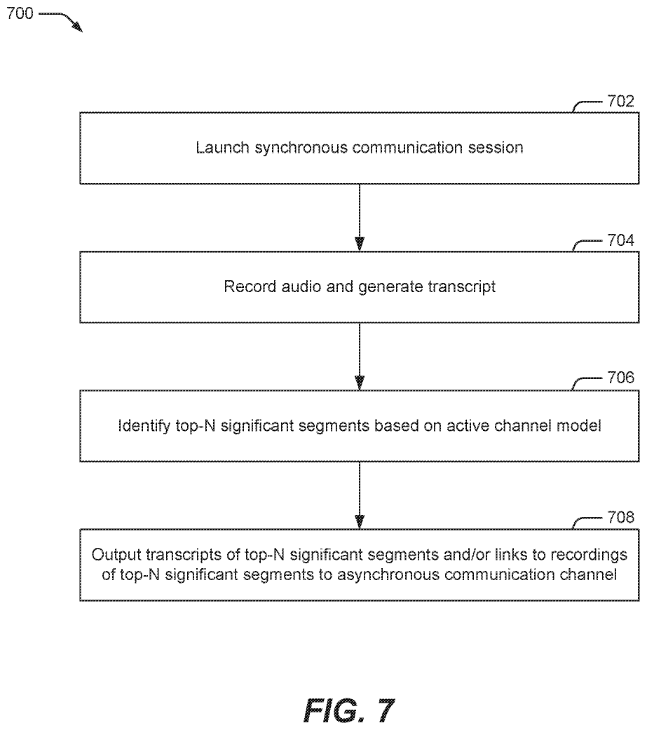

Referring to FIG. 7, a flowchart of a method 700 of identifying significant segments of a synchronous communication session based on an active channel model is shown. The method 700 includes launching a synchronous communication session, at 702. For example, the server device 102 may launch the synchronous communication session 128 in response to the session request 134. The method 700 further includes recording audio of the synchronous communication session and generating a transcript, at 704. For example, the server device 102 may receive the session data 136 and generate a recording and transcript of the synchronous communication session 128.

The method 700 further includes identifying a top-N significant segments based on an active channel model, at 706. For example, the server device 102 may identify a feature vector for each of the segments of the synchronous communication session 128 and compare the feature vectors to an active channel model for the asynchronous communication channel 126 (e.g., the customized channel model 112 or one of the template channel models 114). The server device 102 may then select N closest segments to the active channel model.

The method 700 further includes outputting transcripts of the top-N significant segments and/or links to recordings of the top-N significant segments to an asynchronous communication channel, at 708. For example, the server device 102 may output transcripts of the top-N segments and/or links to recordings of the top-N segments to the asynchronous communication channel 126 as the summarized session data 138.

Thus, the method 700 illustrates how an active channel model may be used to identify segments of a synchronous communication session. Because the active channel model intent, attention, and behavioral transition of an asynchronous communication channel, the segments of the synchronous communication session may be more relevant to users of the asynchronous communication session. Therefore, the method 700 may reduce information loss by automatically identifying potentially relevant information and posting it to an asynchronous communication channel.

In a particular illustrative example, a transcript includes the following segments 001-010.

| Segment Number | Transcript |
|---|---|
| Transcript-001 | So this is what we discussed, right? So the the |
| | clients have ability to choose what they have to |
| | do what they want to send as a participant ID |
| | in case of her Miss. So as we don't have any |
| | part spent ID that we generate as in when |
| | somebody joins we can use user ID as a |
| | participant ID for all our Communications, so |
| | we don't have to do any backfill for anything |
| | problem is we cannot associate |
| Transcript-002 | Basically when slack talks to the user to |
| | negotiate to the user logs into slag/returns |
| | code back to the server so good back to the |
| | client the client forwards it to our server saying |
| | that use this code for negotiating an auth token |
| | with slack when you're talking to it. So in the |
| | past or to slack to negotiate the auth tokens lab |
| | comes back saying this code is already used. |
| Transcript-003 | Operation is complete. It's working in my local |
| | environment properly. I also had to make a |
| | change to you know, separate the events that |
| | are being emitted to use the service and being |
| | just listen to and being sent to the appropriate |
| | Channel like other to web sockets or through |
| | callback URLs that also is done. I need one |
| | review on that and also need to test it a little bit |
| | more thoroughly in staging today. |
| Transcript-004 | There are other things also like Channel Nine's |
| | process comprehend. Yeah that they're gonna |
| | go away. But yeah, but there are few other |
| | things. Also, let's show in today still not show |
| | entities. So it's almost like |
| Transcript-005 | Let's understand what's going on like why it's |
| | going into those repetitive rate. If it is really |
| | going that that like, you know, if we can look |
| | at for example connecting my phone, by the |
| | way, I did connect it to website web inspector |
| | yesterday and try to look at the things but I'm |
| | not seeing anything when the app is doing it. |
| | Right like if I open a safari page and I do it. I |
| | see all the requests but from within my phone, |
| | I'm not seeing it. So we probably need to sit |
| | together and debug this. |
| Transcript-006 | For this event site so basically, right? Okay |
| | currently we're using HTTP request to send the |
| | start and end events. So the plan was to have |
| | Nats implementation for Janice and Ernest. So |
| | that channels will send these events through |
| | Nets to hardness and hardness should be the |
| | subscriber for start and envy. Okay cross it |
| | back |
| Transcript-007 | Next few months, you know even worst case. |
| | Let's say we need to have 10 pre-allocated |
| | instances, right? Yeah, that will get us up to I |
| | don't know even if you say 10 conferences very |
| | conservatively 10 conferences for instance, |
| | which is very very conservative. We do like |
| | 2025, right so you can have 250 simultaneous |
| | conferences, which means there are 200 and |
| | you know to 2500 things, right so which is a |
| | lot so my point is let's not worry too much right |
| | now about that. We'll just go with this woman |
| | one more thing |
| Transcript-008 | Hitting Safari - of right deleting a pre- |
| | installing it. Yeah, I've tried copying pasting in |
| | Chrome the link and try to start. I've tried |
| | everything try going back to an older building |
| | of the so little kind of confuse now on and |
| | again like when I login from Safari directly to |
| | slack over SSO, it also works. |
| Transcript-009 | Some of these things like the markers like |
| | promotion of markers edit markers delete |
| | markers some of those things that are not date |
| | listed, right? Yeah. Some of those things will |
| | also need to be added to the so let's kind of burn |
| | through this whatever we've listed first so that |
| | we can move on to the other ones, |
| Transcript-010 | So I started work on the first item the Jannah |
| | scalability thing. So I think we are already |
| | allocated a machine with the DNS setup and all |
| | those things. So I'll install the Janice Gateway |
| | there. I'm doing some playing around with the |
| | conflicts for setting up the reverse proxy and |
| | with the help of that encrypt and all those |
| | things. So there are some open source projects |
| | like in genetics or traffic or any other are there. |
| | So this is playing around with them and see |
| | what is more suitable for us. So I think to start |
| | off with that start with the genus kind of |
| | reverse proxy with lets it rip so that that will be |
| | done today and apart from that. I was thinking |
| | like I initially we discussed about are having |
| | periodical entity instances that were created |
| | history and scheduling them the help of the |
| | resource ecology that we already place. |

The server device 102 may generate feature vectors for each of the segments 001-010 and compare the feature vectors to the active channel model. The server device 102 may then identify transcript segments 050, 010, and 030 as the three segments closest to the active channel model. Accordingly, the server device 102 may output transcripts of the segments 050, 010, and 030 and/or links to recordings of the segments 050, 010, and 030 to the asynchronous channel 126.

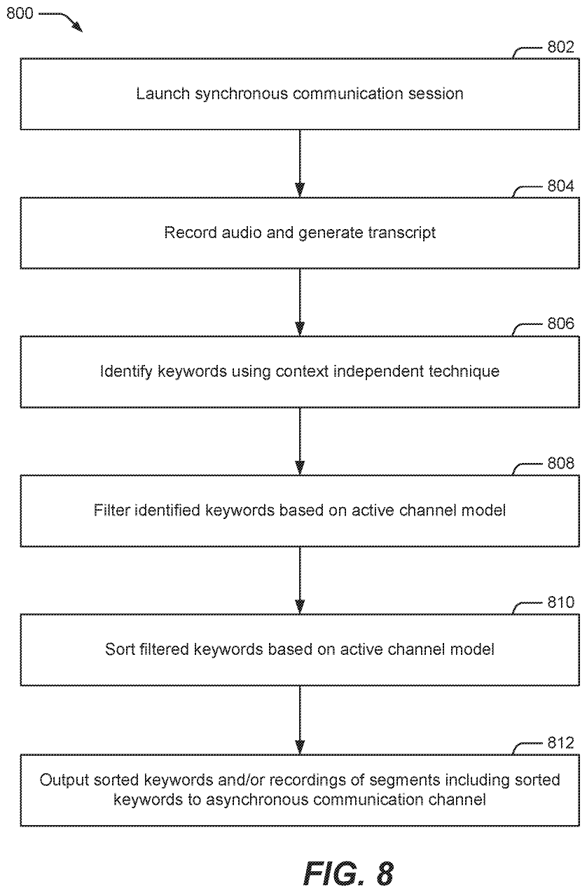

Referring to FIG. 8, a flowchart of a method 800 of identifying keywords of a synchronous communication session based on an active channel model is shown. The method 800 includes launching a synchronous communication session, at 802. For example, the server device 102 may launch the synchronous communication session 128 in response to the session request 134. The method 800 further includes recording audio of the synchronous communication session and generating a transcript, at 804. For example, the server device 102 may receive the session data 136 and generate a recording and transcript of the synchronous communication session 128.

The method 800 further includes identifying keywords using one or more context independent techniques, at 806. For example, the server device 102 may extract keywords from the session data 136 using a context independent technique such as Stanford NLP, Spacy, NLTK n-gram extraction, etc.

The method 800 further includes filtering the identified keywords based on an active channel model, at 808. For example, the server device 102 may identify a feature vector for each of the identified keywords and compare the feature vectors to an active channel model for the asynchronous communication channel 126 (e.g., the customized channel model 112 or one of the template channel models 114). The server device 102 may then select N closest keywords to the active channel model.

The method 800 further includes sorting the filtered keywords based on the active channel model, at 810. For example, the filtered keywords may be ordered based on distance to the active channel model.

The method 800 further includes outputting the sorted keywords and/or recordings of segments including the sorted keywords to an asynchronous communication channel, at 812. For example, the server device 102 may output the sorted keywords and/or links to recordings of segments of the synchronous communication session 128 to the asynchronous channel 126 as the summarized session data 138.

Thus, the method 800 illustrates how an active channel model may be used to identify keywords of a synchronous communication session. Because the active channel model intent, attention, and behavioral transition of an asynchronous communication channel, the keywords may be more relevant to users of the asynchronous communication session. Therefore, the method 800 may reduce information loss by automatically identifying potentially relevant information and posting it to an asynchronous communication channel.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. A method comprising:
providing an asynchronous communication channel;
generating a customized channel model of the asynchronous communication channel based on one or more machine learning techniques and messages received through the asynchronous communication channel; and
outputting data to the asynchronous communication channel based on the customized channel model of the asynchronous communication channel.

2. The method of claim 1, further comprising:
providing a synchronous communication session; and
identifying segments of the synchronous communication session based on the customized channel model of the asynchronous communication channel, wherein the data includes transcripts of the segments, links to recordings of the segments, or a combination thereof.

3. The method of claim 1, further comprising:
providing a synchronous communication session; and
identifying keywords of the synchronous communication session based on the customized channel model of the asynchronous communication channel, wherein the data includes the keywords.

4. The method of claim 1, further comprising associating a template channel model to the asynchronous communication channel prior to generation of the customized channel model.

5. The method of claim 4, further comprising generating test data based on the customized channel model while the template channel model is associated with the asynchronous communication channel and outputting the test data to the asynchronous communication channel.

6. The method of claim 5, further comprising replacing the template channel model with the customized channel model in response to feedback approving the test data.

7. The method of claim 1, wherein the customized channel model corresponds to a word embeddings model of the messages received through the asynchronous communication channel.

8. The method of claim 1, wherein the customized channel model corresponds to a language model of the messages received through the asynchronous communication channel.

9. A device comprising:
one or more processors; and
a memory storing instructions executable by the one or more processors to:
provide an asynchronous communication channel;
generate a customized channel model of the asynchronous communication channel based on one or more machine learning techniques and messages received through the asynchronous communication channel; and
output data to the asynchronous communication channel based on the customized channel model of the asynchronous communication channel.

10. The device of claim 9, wherein the instructions are further executable by the one or more processors to:
provide a synchronous communication session; and
identify segments of the synchronous communication session based on the customized channel model of the asynchronous communication channel, wherein the data includes transcripts of the segments, links to recordings of the segments, or a combination thereof.

11. The device of claim 9, wherein the instructions are further executable by the one or more processors to:
provide a synchronous communication session; and
identify keywords of the synchronous communication session based on the customized channel model of the asynchronous communication channel, wherein the data includes the keywords.

12. The device of claim 9, wherein the instructions are further executable by the one or more processors to associate a template channel model to the asynchronous communication channel prior to generation of the customized channel model.

13. The device of claim 12, wherein the instructions are further executable by the one or more processors to generate test data based on the customized channel model while the template channel model is associated with the asynchronous communication channel and outputting the test data to the asynchronous communication channel.

14. The device of claim 13, wherein the instructions are further executable by the one or more processors to replace the template channel model with the customized channel model in response to feedback approving the test data.

15. The device of claim 9, wherein the customized channel model corresponds to a word embeddings model of the messages received through the asynchronous communication channel.

16. The device of claim 9, wherein the customized channel model corresponds to a language model of the messages received through the asynchronous communication channel.

17. A computer readable storage device storing instructions executable by one or more processors to:
provide an asynchronous communication channel;
generate a customized channel model of the asynchronous communication channel based on one or more machine learning techniques and messages received through the asynchronous communication channel; and
output data to the asynchronous communication channel based on the customized channel model of the asynchronous communication channel.

18. The computer readable storage device of claim 17, wherein the instructions are further executable by the one or more processors to:
provide a synchronous communication session; and
identify segments of the synchronous communication session based on the customized channel model of the asynchronous communication channel, wherein the data includes transcripts of the segments, links to recordings of the segments, or a combination thereof.

19. The computer readable storage device of claim 17, wherein the instructions are further executable by the one or more processors to:
provide a synchronous communication session; and
identify keywords of the synchronous communication session based on the customized channel model of the asynchronous communication channel, wherein the data includes the keywords.

20. The computer readable storage device of claim 17, wherein the instructions are further executable by the one or more processors to associate a template channel model to the asynchronous communication channel prior to generation of the customized channel model.
